(19) United States
(12) Patent Application Publication
(10) Pub. No.: US 2025/0191616 A1
(43) Pub. Date: Jun. 12, 2025

(54) AUDIO TESTING METHOD AND APPARATUS, ELECTRONIC DEVICE, AND STORAGE MEDIUM

(71) Applicant: Beijing Zitiao Network Technology Co., Ltd., Beijing (CN)

(72) Inventors: Saisi Meng, Beijing (CN); Ying Song, Beijing (CN)

(21) Appl. No.: 18/977,160

(22) Filed: Dec. 11, 2024

(30) Foreign Application Priority Data
Dec. 11, 2023 (CN) 202311694327.9

(51) Int. Cl. G11B 27/36; G06F 3/16; G11B 27/34

(52) U.S. Cl. CPC G11B 27/36; G06F 3/165; G11B 27/34

(57) ABSTRACT

An audio testing method includes: obtaining first recorded audio of each record-end and second recorded audio of a playback-end, both of which include background audio that is simultaneously played, and the first recorded audio further includes test audio which is in one-to-one correspondence with the record-ends; obtaining a start time of the background audio in each first recorded audio by performing audio detection on each first recorded audio; obtaining a start time of the background audio and a detection time of each test audio in the second recorded audio by performing audio detection on the second recorded audio; and determining a synchronization test result for the second recorded audio based on the start time of the background audio and the detection time of each test audio in the second recorded audio, and the start time of the background audio in each first recorded audio.

### CROSS-REFERENCE TO RELATED APPLICATION(S)

This application claims priority to Chinese Application No. 202311694327.9 filed on Dec. 11, 2023, the disclosure of which is incorporated herein by reference in its entirety.

### FIELD

The present disclosure relates to the field of computer technology, and specifically, to an audio testing method and apparatus, an electronic device, and a storage medium.

### BACKGROUND

In some audio scenarios, when singing or reciting is performed online based on the same background audio, that is, user audio is added based on the background audio to be output to a playback-end for playback, which requires an analysis on a synchronization status between the background audio and the user audio. For example, in a real-time chorus scenario, from the perspective of an audience end, an expected effect is to hear a plurality of voices and accompaniment that are aligned in progress, meaning that the voices of all singers are synchronized with the accompaniment.

### SUMMARY

In a first aspect, the present disclosure provides an audio testing method, including:
obtaining first recorded audio of each record-end and second recorded audio of a playback-end, wherein both the first recorded audio and the second recorded audio comprise background audio that is simultaneously played, the first recorded audio further comprises test audios which are in one-to-one correspondence with the record-ends, the test audios are played by playback devices of the record-ends, the second recorded audio is playback audio of the playback-end, and the playback audio comprises the background audio and all test audio played by the playback-end;
obtaining a start time of the background audio in each first recorded audio by performing audio detection on each first recorded audio;
obtaining a start time of the background audio and a detection time of each test audio in the second recorded audio by performing audio detection on the second recorded audio; and
determining a synchronization test result for the second recorded audio based on the start time of the background audio and the detection time of each test audio in the second recorded audio, and the start time of the background audio in each first recorded audio.

In a second aspect, the present disclosure provides an audio test apparatus, including:
a recorded audio obtaining module, configured to obtain first recorded audio of each record-end and second recorded audio of a playback-end, wherein both the first recorded audio and the second recorded audio comprise background audio that is simultaneously played, the first recorded audio further comprises test audios which are in one-to-one correspondence with the record-ends, the test audios are played by playback devices of the record-ends, the second recorded audio is playback audio of the playback-end, and the playback audio comprises the background audio and all test audio played by the playback-end;
a first audio detection module, configured to obtain a start time of the background audio in each first recorded audio by performing audio detection on each first recorded audio;
a second audio detection module, configured to obtain a start time of the background audio and a detection time of each test audio in the second recorded audio by performing audio detection on the second recorded audio; and
a synchronization test module, configured to determine a synchronization test result for the second recorded audio based on the start time of the background audio and the detection time of each test audio in the second recorded audio, and the start time of the background audio in each first recorded audio.

In a third aspect, the present disclosure provides an electronic device, including a memory and a processor, where the memory and the processor are in mutual communication connection, the memory stores computer instructions, and the processor executes the computer instructions to perform the audio testing method in the first aspect or any corresponding implementation.

In a fourth aspect, the present disclosure provides a computer-readable storage medium. The computer-readable storage medium stores computer instructions, and the computer instructions are used to allow a computer to perform the audio testing method in the first aspect or any corresponding implementation.

In a fifth aspect, the present disclosure provides an audio test system, including:
a plurality of record-ends, wherein each record-end comprises a first playback device, a third playback device, and a first record device, all the first playback devices are configured to simultaneously play background audio, the third playback devices are configured to simultaneously play test audio corresponding to the record-ends, and the first record devices are configured to record the background audio and the test audio to obtain first recorded audio;
a playback-end, comprising a second playback device and a second record device, wherein the second playback device is configured to play the test audio played by all the third playback devices and to play the background audio simultaneously with the first playback devices, and the second record device is configured to record the audio played by the second playback device to obtain second recorded audio; and
the electronic device according to the third aspect, where the electronic device is respectively connected with the devices of the record-ends and the playback-end.

### BRIEF DESCRIPTION OF THE DRAWINGS

In order to describe technical solutions in specific implementations of the present disclosure or the prior art more clearly, accompanying drawings required to be used in the descriptions of the specific implementations or the prior art will be simply introduced below. It is apparent that the accompanying drawings described below are some implementations of the present disclosure, and those of ordinary skill in the art can obtain other accompanying drawings according to these accompanying drawings without creative work.

FIG. 1 is a schematic diagram of a structure of an audio test system according to embodiments of the present disclosure;

FIG. 2 is a schematic diagram of a structure of another audio test system according to embodiments of the present disclosure;

FIG. 3 is a schematic flowchart of an audio testing method according to embodiments of the present disclosure;

FIG. 4 is a schematic flowchart of another audio testing method according to embodiments of the present disclosure;

FIG. 5 is a schematic diagram of first recorded audio and second recorded audio according to embodiments of the present disclosure;

FIG. 6 is a schematic flowchart of another audio testing method according to embodiments of the present disclosure;

FIG. 7 is a block diagram of a structure of an audio test apparatus according to embodiments of the present disclosure; and

FIG. 8 is a schematic diagram of a hardware structure of an electronic device according to embodiments of the present disclosure.

### DETAILED DESCRIPTION OF EMBODIMENTS

In order to have a clearer understanding of the objectives, technical solutions, and advantages of embodiments of the present disclosure, the technical solutions in the embodiments of the present disclosure are clearly and completely described in conjunction with the accompanying drawings in the embodiments of the present disclosure, and it is apparent that the described embodiments are only a part rather all of embodiments of the present disclosure. Based on the embodiments of the present disclosure, all other embodiments obtained by those skilled in the art without creative work shall fall within the scope of protection of the present disclosure.

It should be understood that before the use of the technical solutions disclosed in the embodiments of the present disclosure, a user shall be informed of the type, range of use, use scenarios, etc., of personal information involved in the present disclosure in an appropriate manner in accordance with relevant laws and regulations, and the authorization of the user shall be obtained.

For example, in response to reception of an active request from the user, a prompt message is sent to the user to clearly inform the user that a requested operation will require access to and use of the personal information of the user. As such, the user can independently choose, based on the prompt message, whether to provide the personal information to software or hardware, such as an electronic device, an application, a server, or a storage medium, that performs the operations of the technical solutions of the present disclosure.

As an optional but non-limiting implementation, in response to the reception of the active request from the user, the method for sending the prompt message to the user may be, for example, a pop-up window, in which the prompt message may be presented in text. Further, the pop-up window may also carry a selection control for the user to choose whether to “agree” or “disagree” to provide the personal information to the electronic device.

It should be understood that the above notification and user authorization obtaining process is only illustrative, which does not limit the implementations of the present disclosure, and other methods that comply with the relevant laws and regulations may also be applied to the implementations of the present disclosure.

It should be understood that data (including but not limited to the data itself, and data acquisition, or usage) involved in the technical solutions should comply with the requirements of the corresponding laws and regulations, and relevant stipulations.

As described above, in some audio scenarios, when singing or reciting is performed online based on the same background audio, that is, user audio is added based on the background audio to be output to a playback-end for playback, which requires an analysis on a synchronization status between the background audio and the user audio. For example, in a real-time chorus scenario, from the perspective of an audience end, an expected effect is to hear a plurality of voices and accompaniment that are aligned in progress, meaning that the voices of all singers are synchronized with the accompaniment. Based on this, to achieve this effect, it is necessary to test a synchronization degree between the voices and the accompaniment in the chorus scenario to meet the requirement for voice-accompaniment synchronization.

In the related art, for a synchronization test between user audio and background audio, the background audio and the real-person output audio are played at a record-end, the background audio and the real-person output audio are sent to a playback-end to be played after being recorded, and a tester performs a synchronization degree analysis on the heard audio at the playback-end based on experience, thereby obtaining a synchronization analysis result. However, the process relies on a real person to output audio, and the synchronization analysis result is also based on the experience of the tester, leading to a subjective test result that cannot be reproduced.

Taking a chorus scenario as an example, factors affecting user experience in the chorus scenario include not only some functional effects and audio quality effects such as synchronization between music and lyrics in progress, ear monitor audio quality, device switching experience, and volume balance, but also, most importantly, synchronization between voices and accompaniment, namely voice-accompaniment synchronization. For an audience end, the expected effect is to hear a plurality of voices and accompaniment that are aligned in progress, meaning that the voices of all singers are synchronized with the accompaniment, thereby reproducing an offline chorus as much as possible. However, due to inconsistent delays introduced when an audio processing chain processes the voices and the accompaniment, the voices and the accompaniment cannot be precisely aligned during mixing. In a practical scenario, it is represented as the singers singing along with the accompaniment, but the audience hears the voices of the singers as out of sync with the accompaniment, that is, the voices are ahead of or lag behind the accompaniment. For the scenario, a voice-accompaniment synchronization test in the related art is implemented based on an active test, which involves finding a plurality of people to act as singers, using different devices to sing a song together online, and subjectively testing the synchronization status between the voice of each singer and the accompaniment at the audience end.

However, in the above solution, since the chorus voice-accompaniment synchronization test is a subjective test with real-person singing, it is greatly influenced by the singing skills of the singers and requires high hearing requirements for the tester for audition, and as a result, the test result is significantly influenced by subjective factors.

Based on this, embodiments of the present disclosure provide an audio testing method, to solve the problem about a synchronization test on audio. Test audio is played to simulate user-output audio, and corresponding first recorded audio is recorded for each record-end; and background audio and the test audio played by each record-end are played at a playback-end to simulate audio heard by the user at the playback-end, and the audio played at the playback-end is recorded to obtain second recorded audio. Audio detection is performed on the first recorded audio and the second recorded audio to obtain a start time of respective background audio and a detection time of the test audio of each record-end in the second recorded audio, and through a time comparative analysis, a synchronization test result for the second recorded audio can be obtained. The synchronization test result includes, but is not limited to, the synchronization status between the test audio of each record-end and the background audio, a background audio delay of each record-end, and the synchronization status between the record-ends.

According to the audio testing method, the user audio is simulated by playing the test audio, and there is no real user audio, thereby avoiding errors caused by subjective factors of the user leading to out-of-sync user audio and background audio. Meanwhile, through the method, a device coverage test can be achieved, and voice-accompaniment synchronization of a plurality of devices can be simultaneously tested at a time.

If the audio testing method is applied to the chorus scenario, there is no real-person singing, a playback device is utilized for playing the test audio to replace singer singing, thereby avoiding errors caused by real-person singing being out of sync with the accompaniment.

According to the audio testing method provided in the embodiments of the present disclosure, for all the record-ends, the same background audio and the test audio being in one-to-one correspondence with the record-ends are played, where the test audio is automatically-played audio and is not manually-output audio, which can ensure objectivity of the test result; meanwhile, the first recorded audio includes the background audio and the test audio of the corresponding record-ends, the second recorded audio includes the same background audio and the test audio played by the playback devices of all the record-ends, the playback of the audio by the playback-end is simulated through the second recorded audio, and the audio detection is performed on the first recorded audio and the second recorded audio to obtain the start times of the background audio in the first recorded audio, the start time of the background audio in the second recorded audio, and the detection times of the test audio, and therefore the synchronization test result corresponding to each record-end can be represented in the second recorded audio. The entire test process is automatically achieved without manual audio output, thereby avoiding the influence of human subjective factors on the test result, and ensuring the accuracy of the synchronization test result in an objective manner.

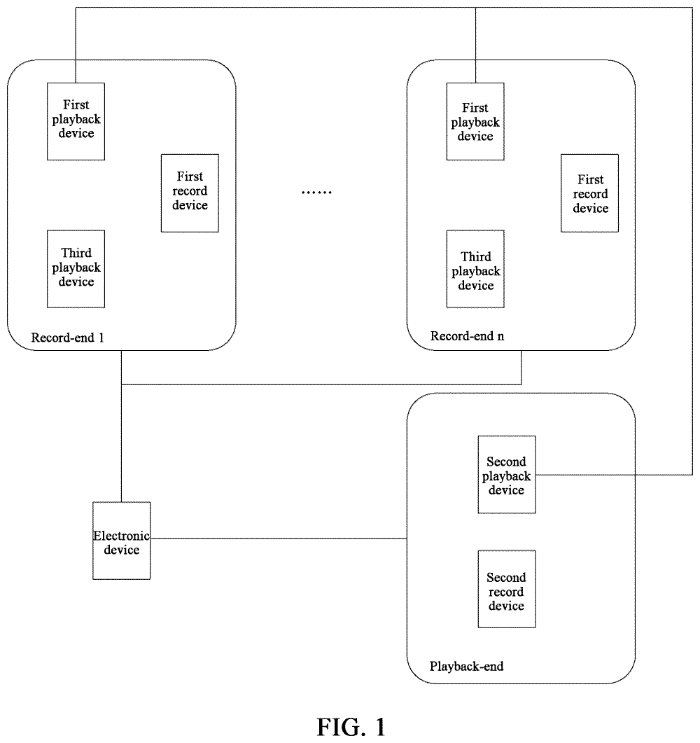

Embodiments of the present disclosure further provide an audio test system. As shown in FIG. 1, the system can test devices at n record-ends at the same time. Each record-end includes a first playback device, a first record device, and a third playback device. The first playback device is configured to play background audio, the third playback device is configured to play test audio corresponding to the record-end, the test audio is in one-to-one correspondence with the record-ends, and the first record device is configured to record the background audio and the test audio to obtain first recorded audio. Specifically, the test audio played by the third playback device may be single-frequency tones of different frequencies, or may be replaced by other different percussive sounds or signals of varying lengths. The specific form of the test audio is not limited herein, which is set according to actual needs.

The first record device is configured to record the audio played by the first playback device and the third playback device to obtain the first recorded audio. The first recorded audio includes background audio and test audio at the record-end. A playback-end is configured to simulate audio output by n users based on the same background audio that the user hears. The playback-end includes a second playback device and a second record device. The second playback device is configured to play the background audio and the test audio played by the n record-ends. The test audio played by the record-ends is sent to the record-ends, played by the second playback device at the playback-end, and then recorded by the second record device to obtain the second recorded audio.

During the test, the first playback devices of all the record-ends and the second playback device of the playback-end play the background audio at the same time. The first record devices of all the record-ends and the second record device of the playback-end start to recording at the same time, and the recording start time may be the playback time of the background audio or may be after the background audio has been played for a period of time. The recording time is not limited herein, which is specifically set according to actual needs.

An electronic device is configured to control the devices of the record-ends and the devices of the playback-end, such as controlling the playback of the background audio at the record-ends and the playback-end, controlling the playback of the test audio at the record-ends, and controlling recording by the first record devices and the second record devices.

In the test process, to avoid the influence of other audio on the test result, the record-ends and the playback-end need to be tested in a quiet environment. For example, the record-ends are arranged in soundproof boxes, or each record-end is placed in a separate testing room. The first playback device, the second playback device, and the third playback device may use artificial mouths or other devices with an audio playback function. The first record device and the second record device may use standard microphones or other settings with an audio recording function. The electronic device may use a sound card or may be replaced with any other apparatus that may control a plurality of record or playback devices for simultaneous recording or playback.

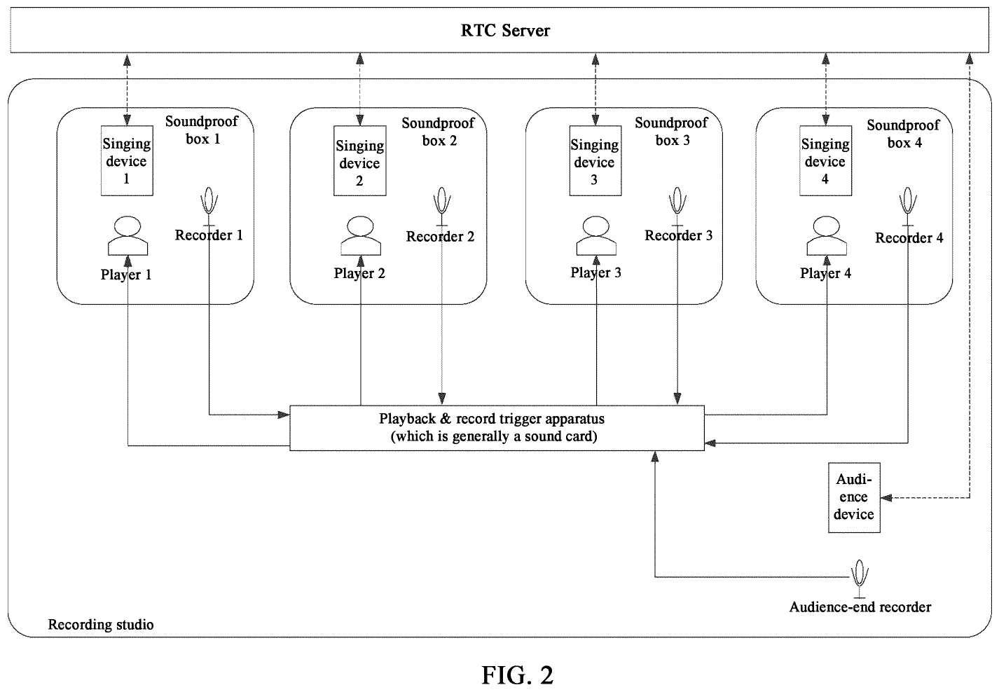

In some optional implementations, taking a synchronization test in the chorus scenario as an example, FIG. 2 illustrates a specific application example of an audio test system. In a recording studio, a soundproof box is used for each record-end, and there are totally four soundproof boxes used to test synchronization performance corresponding to four singing devices. A singing device, a player, and a recorder are arranged in each soundproof box. The singing devices 1 to 4 correspond to the first playback devices in FIG. 1, the players 1 to 4 correspond to the third playback devices in FIG. 1, and the recorders 1 to 4 correspond to the first record devices in FIG. 1; and for a playback-end, an audience device corresponds to the second playback device in FIG. 1, and a record device at an audience end corresponds to the second record device in FIG. 1.

Specifically, the four separate, sealed, and non-interfering soundproof boxes are placed in the same recording studio. One singing device, one recorder for audio recording, and one player for playing test audio to simulate the singer voice are placed in each soundproof box. A playback & record trigger apparatus corresponds to the electronic device in FIG. 1, generally uses a sound card, and is configured to allow the player in each soundproof box for sound playback. The record trigger apparatus is configured to allow the recorder in each soundproof box to synchronously perform sound recording. Meanwhile, the singing devices in the soundproof boxes send the collected test audio played by the players to an audience-end device for playback. Correspondingly, an audience-end recorder may collect the background audio and the test audio played by the players of the record-ends.

In a multi-person chorus scenario, a user A selects a song in chorus application software as accompaniment and supports users B\C\D to join the chorus, that is, the users A to D sing the song together with the accompaniment, sometimes sing in turns, and sometimes sing together, while other audiences listen to a chorus effect of the plurality of singers. According to the above chorus method, the test scenario includes real-time chorus-round singing and real-time chorus-unison singing, where the round singing means that the users A to D sing in turns with no overlap in voices; and the unison singing means that the users A to D sing together with overlap in voices.

Real-time chorus scenarios are divided into a round singing scenario and a unison singing scenario. In the round singing scenario, the players are triggered in sequence by number to play audio, while the correspondingly-numbered recorders and the audience-end recorder are triggered for audio recording, thereby obtaining first recorded audio of each singing terminal and second recorded audio of the audience end, and then utilizing the first recorded audio and the second recorded audio to obtain round singing-related metrics. In the unison singing scenario, all the players are simultaneously triggered to play audio, and meanwhile, the correspondingly-numbered recorders and the audience-end recorder are triggered for audio recording, thereby utilizing the first recorded audio and the second recorded audio to obtain the round singing-related metrics.

Taking FIG. 2 as an example, the singing devices 1 to 4 play the accompaniment simultaneously. During round singing, the players 1 to 4 are triggered in turns to play the test audio. The recorders 1 to 4 and the audience-end recorder are simultaneously triggered for audio recording. During unison singing, the players 1 to 4 are simultaneously triggered to simultaneously play corresponding test audio, and the recorders 1 to 4 are triggered for simultaneous audio recording. During round singing, the players play the test audio in sequence, with only one person singing at a time; and during unison singing, all the players play the test audio simultaneously, with all singers singing together. Whether it is round singing or unison singing, the correspondingly-numbered recorders are triggered simultaneously. In combination with the audio testing method provided in the embodiments of the present disclosure, a voice-accompaniment synchronization degree of each singer in the round singing scenario and the unison singing scenario can be calculated, and meanwhile a synchronization degree of local players of all the singers and an alignment degree of voices of all the singers heard by the audience end may also be simultaneously output in the unison singing scenario.

According to embodiments of the present disclosure, embodiments of an audio testing method are provided. It should be noted that the steps shown in the flowchart of the accompanying drawings may be performed in a computer system such as a set of computer-executable instructions. In addition, although a logical order is shown in the flowchart, the illustrated or described steps may be performed in a different order than presented herein in some cases.

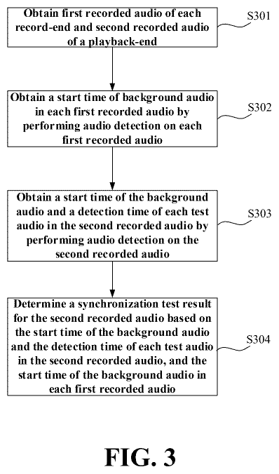

In this embodiment, an audio testing method is provided, which may be used in an electronic device, such as a computer and a mobile terminal. FIG. 3 is a flowchart of an audio testing method according to embodiments of the present disclosure. As shown in FIG. 3, the process includes the following steps:

Step S301: Obtain first recorded audio of each record-end and second recorded audio of a playback-end.

Both the first recorded audio and the second recorded audio include background audio that is simultaneously played, the first recorded audio further includes test audio which is in one-to-one correspondence with the record-ends, the test audios are played by playback devices of the record-ends, the second recorded audio is playback audio of the playback-end, and the playback audio includes the background audio and all test audio played by the playback-end.

It should be noted that there may be one, or two, or more record-ends in this embodiment, which is specifically set according to actual test requirements, and is not limited herein. The first recorded audio is in one-to-one correspondence with the record-ends, and includes background audio and test audio played by the playback devices of the record-ends. As shown above, the playback devices of all the record-ends and the playback-end simultaneously play the background audio. Because the playback devices may have different playback delays, there is a delay in start time of the background audio recorded by the record devices of the record-ends. All the record devices start recording simultaneously. The time of starting recording may be before, during, or after playing the background audio, which is not specifically limited.

The first recorded audio also includes test audio which is in one-to-one correspondence with the record-ends, and the test audio is used to simulate the user audio. For example, the test audio is single-frequency tones of different frequencies. In combination with FIG. 1, all the first playback devices and the second playback device simultaneously play the background audio, the third playback devices play the test audio, and all the first record devices and the second record device simultaneously start recording. Because the test audio of the third playback devices can be received by the first playback devices and sent to the second playback device, correspondingly, the audio played by the second playback device includes the background audio and the test audio of the record-ends. The playback-end records the audio played by the second playback device to obtain second recorded audio.

Step S302: Obtain a start time of background audio in each first recorded audio by performing audio detection on each first recorded audio.

If there are a plurality of record-ends, a plurality of pieces of first recorded audio being in one-to-one correspondence with the record-ends are obtained. The processing of the plurality of pieces of first recorded audio may be performed in parallel or sequentially, etc. For performing the audio detection on the first recorded audio to obtain the start time of the background audio, a detection method may include obtaining a feature of the background audio, then performing feature extraction on the first recorded audio, and comparing the two features to obtain the start time of the background audio. Alternatively, both the background audio and the first recorded audio may be converted to a frequency domain and subjected to alignment processing in the frequency domain, thereby obtaining the start time of the background audio.

As shown above, although all the first playback devices simultaneously play the background audio, because the first record devices may have different playback delays, the start times of the background audio recorded by the first record-ends are different. Through the above processing method, the start time of the background audio in each first recorded audio can be obtained. If the test method involves the record-ends 1 to n, correspondingly, the first recorded audio 1 to n is obtained, and the start times of the background audio in the first recorded audio 1 to n are respectively t1 to tn.

Step S303: Obtain a start time of the background audio and a detection time of each test audio in the second recorded audio by performing audio detection on the second recorded audio.

The second recorded audio includes the background audio and the test audio of each record-end. The detection method for the background audio is similar to step S302, thereby obtaining the start time t of the background audio in the second recorded audio. The test audio is in one-to-one correspondence with the record-ends, and correspondingly, different test audio has different features. Based on this, through an audio feature detection method, each test audio is detected from the second recorded audio, thereby obtaining the detection time of each test audio. The detection time of the test audio is the time when the playback-end plays the test audio, which may also be considered as the start time of the test audio in the second recorded audio. For ease of description, the detection times of the test audio from the record-ends 1 to n in the second recorded audio are labeled as T1 to Tn.

Because the first playback devices have different acquisition delays, the start times of the test audio received by the playback-end are not aligned with the background audio. Alternatively, in a scenario where the test audios are simultaneously played, due to the different acquisition delays of the first playback devices, the test audio, received by the playback-end, from the record-ends is not aligned, and the delays introduced when the audio processing chain processes the test audio and the background audio are not consistent, resulting in inaccurate alignment between the test audio and the background audio during mixing. Therefore, in the second recorded audio, it is embodied that each test audio has a corresponding detection time.

It should be noted that an implementation for the audio detection is not limited herein, which is specifically set according to actual needs.

Step S304: Determine a synchronization test result for the second recorded audio based on the start time of the background audio and the detection time of each test audio in the second recorded audio, and the start time of the background audio in each first recorded audio.

If there is only one record-end, the start time of the background audio in the first recorded audio may be compared with the start time of the background audio in the second recorded audio, thereby obtaining a delay of the start time of the background audio; and the time when the record-end plays the test audio is compared with the detection time of the test audio in the second recorded audio to obtain a delay of the test audio. A voice-accompaniment asynchrony degree is obtained based on a difference between the detection time of the test audio in the second recorded audio and the playback time of the test audio, as well as a difference in the delays of the start times of the background audio, where the voice-accompaniment asynchrony degree is used to represent an asynchrony degree between the test audio and the background audio.

If there are a plurality of record-ends, the synchronization status of the test audio of the record-ends and an alignment degree of all the test audio in the practical scenario may be calculated. Certainly, in the case of the plurality of record-ends, the synchronization status of a single record-end may also be tested. The specific determination of text metrics in the synchronization test result for the second recorded audio is set according to actual needs, which is not limited herein.

According to the audio testing method provided in this embodiment, for all the record-ends, the same background audio and the test audio being in one-to-one correspondence with the record-ends are played, where the test audio is automatically-played audio and is not manually-output audio, which can ensure objectivity of the test result; meanwhile, the first recorded audio includes the background audio and the test audio of the corresponding record-ends, the second recorded audio includes the same background audio and the test audio played by the playback devices of all the record-ends, the playback of the audio by the playback-end is simulated through the second recorded audio, and the audio detection is performed on the first recorded audio and the second recorded audio to obtain the start times of the background audio in the first recorded audio, the start time of the background audio in the second recorded audio, and the detection times of the test audio, and therefore the synchronization test result corresponding to each record-end can be represented in the second recorded audio. The entire test process is automatically achieved without manual audio output, thereby avoiding the influence of human subjective factors on the test result, and ensuring the accuracy of the synchronization test result in an objective manner.

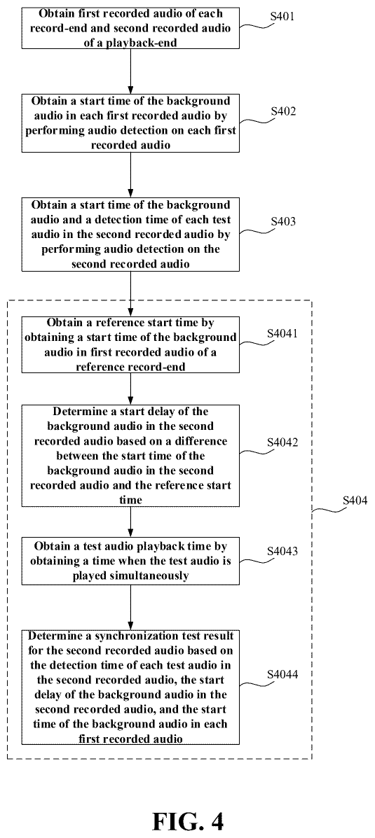

In this embodiment, an audio testing method is provided, which may be used in an electronic device, such as a computer and a mobile terminal. FIG. 4 is a flowchart of an audio testing method according to embodiments of the present disclosure. As shown in FIG. 4, the process includes the following steps:

Step S401: Obtain first recorded audio of each record-end and second recorded audio of a playback-end.

Both the first recorded audio and the second recorded audio include background audio that is simultaneously played, the first recorded audio further includes test audio which is in one-to-one correspondence with the record-ends, the test audios are played by playback devices of the record-ends, the second recorded audio is playback audio of the playback-end, and the playback audio includes the background audio and all test audio played by the playback-end. Please refer to step S301 in the embodiments shown in FIG. 3 for details, which are not repeated herein.

Step S402: Obtain a start time of the background audio in each first recorded audio by performing audio detection on each first recorded audio. Please refer to step S302 in the embodiments shown in FIG. 3 for details, which are not repeated herein.

Step S403: Obtain a start time of the background audio and a detection time of each test audio in the second recorded audio by performing audio detection on the second recorded audio. Please refer to step S303 in the embodiments shown in FIG. 3 for details, which are not repeated herein.

Step S404: Determine a synchronization test result for the second recorded audio based on the start time of the background audio and the detection time of each test audio in the second recorded audio, and the start time of the background audio in each first recorded audio.

Specifically, step S404 includes:

Step S4041: Obtain a reference start time by obtaining a start time of the background audio in first recorded audio of a reference record-end.

The start time of the background audio in each first recorded audio is obtained from step S402, one of the record-ends is selected as the reference record-end, and the start time of the background audio in first recorded audio of the reference record-end is used as the reference start time. For example, the first record-end is used as the reference record-end. Certainly, the reference record-end is set according to actual needs, which is not limited herein.

In the chorus scenario, different record-ends correspond to different singers. If there are n singers, there will be n corresponding record-ends, and first recorded audio is obtained in each record-end. The background audio in the first recorded audio is recorded accompaniment.

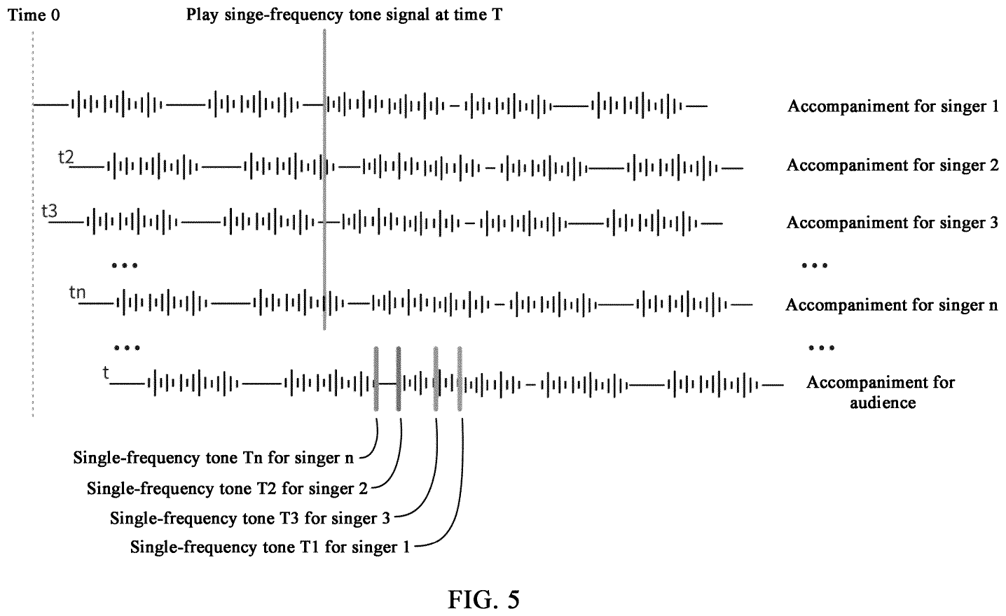

For example, accompaniment corresponding to n singers is shown in FIG. 5, and the accompaniment is recorded. As described above, due to the playback delays of the playback devices of the record-ends, there is a delay in the recorded accompaniment. In FIG. 5, the start times of the recorded accompaniment corresponding to the singers 1 to n are 0, t1 to tn. The record-end of the singer 1 is determined as the reference record-end, and correspondingly, the start time of the background audio is determined as time 0.

Step S4042: Determine a start delay of the background audio in the second recorded audio based on a difference between the start time of the background audio in the second recorded audio and the reference start time.

The start time t of the background audio in the second recorded audio is obtained through step S403, and is used to represent the start time of the background audio heard at the playback-end. The difference between the start time of the background audio in the second recorded audio and the reference start time is determined as the start delay of the background audio in the second recorded audio. If the reference start time is determined as the time 0, the start delay of the background audio in the second recorded audio is t.

Step S4043: Obtain a test audio playback time by obtaining a time when the test audio is played simultaneously.

The time when the test audio is played simultaneously is denoted as T. For example, after the background audio is played for 5 s, the test audio is played, and therefore the 5 s is determined as the test audio playback time. The playback time of the test audio is set according to actual needs, which is not limited herein. In the test process, the test audio of each record-end may be played only once or may be played for several times as needed. The intervals between each playback of the test audio may be the same or different, and so on.

Step S4044: Determine a synchronization test result for the second recorded audio based on the detection time of each test audio in the second recorded audio, the start delay of the background audio in the second recorded audio, and the start time of the background audio in each first recorded audio.

The synchronization test result includes an asynchrony degree between the test audio, heard at the playback-end, of each record-end and the background audio, which is referred to as the voice-accompaniment asynchrony degree, denoted as list A. In the chorus scenario, the synchronization test result refers to the asynchrony degree between the voices of individual singers and the accompaniment as heard at the audience end when a plurality of people start to sing at the same time.

The synchronization test result may also include a playback device asynchrony degree, which is used to represent a delay difference between the background audio recorded by different record-ends, and is denoted as list B. In the chorus scenario, the synchronization test result refers to a delay difference between the locally played accompaniments by the plurality of people.

The synchronization test result may also include an alignment degree of the test audio, heard at the playback-end, from all the record-ends, which is denoted as list C. In the chorus scenario, the synchronization test result refers to the alignment degree of the voices of all singers as heard at the audience end, specifically the delay difference between the start time of singing by each singer that is received at the audience end and the start time of singing by a reference singer when a plurality of people start to sing at the same time.

The synchronization test result may also include an alignment degree of audio, heard at the playback-end, from all the record-ends in a real scenario, namely list D. The difference between the list D and the list C is that in the list C, only the delay of the test audio is considered, while the list D is comprehensively obtained by combining the delay of the background audio and the delay of the test audio. In the chorus scenario, the synchronization test result is used to represent the alignment degree of the voices of all singers as heard at the audience end in a practical real singing scenario, and refers to the delay difference between the start time of singing by each singer that is received at the audience end and the start time of singing by the reference singer when a plurality of people actually singe according to locally played accompaniment. In the chorus scenario, the difference between the list D and the list C is that the list D is calculated based on the list B and the list C, and in the practical chorus process, due to different device playback delays of the singers, the locally played accompaniment of all the singers is not synchronous, each singer sings in sync according to the locally played accompaniment, and therefore the list D represents the alignment degree of the voices of all the singers in the real chorus scenario.

The synchronization test result may also include a difference between a maximum value and a minimum value of the above list D, denoted as delay_align. In the chorus scenario, an actual audience-end alignment degree is defined as a maximum relative delay difference of all the singers that is received by the audience end, referred to as the alignment degree (i.e., a time difference between the earliest singing and the latest singing heard at the audience end).

It should be noted that taking the chorus scenario as an example, if a voice-accompaniment synchronization degree calculation result is a positive value, it indicates that the accompaniment is ahead of the voices, and if the voice-accompaniment synchronization degree calculation result is a negative value, it indicates that the voices are ahead of the accompaniment; and if an alignment degree calculation result is a positive value, it indicates that the voice of the current singer lags behind the voice of the reference singer, and if the alignment degree calculation result is a negative value, it indicates that the voice of the current singer is ahead of the voice of the reference singer.

In some optional implementations, step S4044 includes:

Step a1: Obtain a test audio time difference corresponding to each record-end based on a difference between a detection time of the test audio corresponding to each record-end in the second recorded audio and the test audio playback time.

Step a2: Obtain a background audio time difference corresponding to each record-end based on a difference between the start delay of the background audio and the start time of the background audio in each first recorded audio.

Step a3: For each record-end, obtain an asynchrony degree between the test audio and the background audio based on a difference between the test audio time difference and the background audio time difference, where the synchronization test result includes the background audio time difference corresponding to each record-end and the asynchrony degree between the test audio and the background audio.

The test audio playback time is denoted as T, the detection times of the test audio corresponding to the record-ends in the second recorded audio are represented as T1 to Tn, and therefore, the test audio time differences corresponding to the record-ends 1 to n are represented as [T1−T, T2−T, . . . , Tn−T−].

If the reference start time is determined as the time 0, the start delay of the background audio in the second recorded audio is t, and the start times of the background audio in all the first recorded audio are represented as 0, t2 to tn, namely list B=[0, t2, . . . , tn]. Based on this, the background audio time differences corresponding to all the record-end are represented as [t, t−t2, t−t3, . . . , t−tn].

For each record-end, the asynchrony degree list A between the test audio and the background audio is obtained based on the difference between the test audio time difference and the background audio time difference in the second recorded audio, and is represented as list A=[(T1−T)−t, (T2−T)−(t−t2), . . . , (Tn−T−)−(t−tn)]. Elements in the list A are in one-to-one correspondence with the record-ends. The first element corresponds to the first record-end, the second element corresponds to the second record-end, and in a similar way, the n^{th} element corresponds to the n^{th} record-end.

Due to the influence from the playback performance of each playback device, playback delays may be caused. Based on this, the corresponding background audio time difference is obtained based on the start time of the background audio in the first recorded audio of each record-end, thereby obtaining the synchronization analysis result for the playback device. Meanwhile, the voice-accompaniment synchronization degree of each record-end may be obtained based on the test audio time difference and the background audio time difference.

In some optional implementations, step S4044 includes:

Step b1: Obtain a reference start time of the test audio by obtaining a detection time of test audio corresponding to the reference record-end in the second recorded audio.

Step b2: Obtain a first synchronization test result for the test audio corresponding to each record-end based on a difference between the detection time of each test audio in the second recorded audio and the reference start time of the test audio.

The detection times of the test audio corresponding to the reference record-end in the second recorded audio are represented as T1 to Tn. If the first record-end is taken as the reference record-end, the reference start time of the test audio is T1. By calculating the difference between the detection time of each test audio in the second recorded audio and the reference start time of the test audio, the first test audio synchronization test result corresponding to each record-end is obtained, namely list C, where list C=[0, T2−T1, . . . , Tn−T−1]. Elements in the list C are in one-to-one correspondence with the record-ends.

The first test audio synchronization test result is used to represent the delay difference of the test audio of the other record-ends relative to the reference record-end, indicating the synchronization status of the test audio of each record-end.

In some optional implementations, step S4044 includes: obtaining a second synchronization test result of test audio corresponding to each record-end based on a sum of the start times of the background audio in the each first recorded audio and the first synchronization test results of test audio corresponding to each record-end.

The start times of the background audio in the first recorded audio are represented as list B=[0, t2, . . . , tn], the first synchronization results for the test audio corresponding to the record-ends are represented as list C=[0, T2−T1, . . . , Tn−T−1], and the sum of the two kinds of lists is used to represent the second synchronization test results of test audio corresponding to the record-ends:

$$list D = list B + list C = [ 0 , T 2 - T 1 + t 2 , … , Tn - T 1 + tn ] .$$

In the practical scenario, due to different device playback delays of participants, the locally played background audio is asynchronous, the participants clap along with the locally played background audio, and by utilizing the second synchronization test results of test audio, the alignment degree of voices of all the participants heard at the playback-end in the practical scenario can be represented.

In some optional implementations, step S4044 includes:

Step c1: Obtain a maximum value and a minimum value of the second synchronization test results of test audio by comparing the second synchronization test results of test audio corresponding to the record-ends.

Step c2: Obtain a maximum relative delay difference of the test audio based on a difference between the maximum value and the minimum value.

The second synchronization test results of test audio are compared to obtain the maximum value max (list D) and the minimum value min (list D) among the second synchronization test results of test audio. By calculating the difference between the maximum value and the minimum value, the maximum relative delay difference delay_align of the test audio is obtained, which is represented as: delay_align=max (list D)−min (list D).

By comparing the maximum value and the minimum value among the second synchronization test results of test audio, the difference between the two is used to represent a time difference between the earliest sound and the latest sound heard at the playback-end.

According to the audio testing method provided in this embodiment, one reference record-end is determined from all the record-ends, and the start time of the background audio in the first recorded audio of the reference record-end is used as the reference start time, thereby obtaining the start delays of the background audio corresponding to the record-ends; and then, the time when the test audios are simultaneously played is obtained and used as a reference for the test audio, and after obtaining the reference start time of the background audio and the reference for the test audio, on this basis, the synchronization test analysis is performed on the second recorded audio, and therefore the accurate synchronization test result can be obtained.

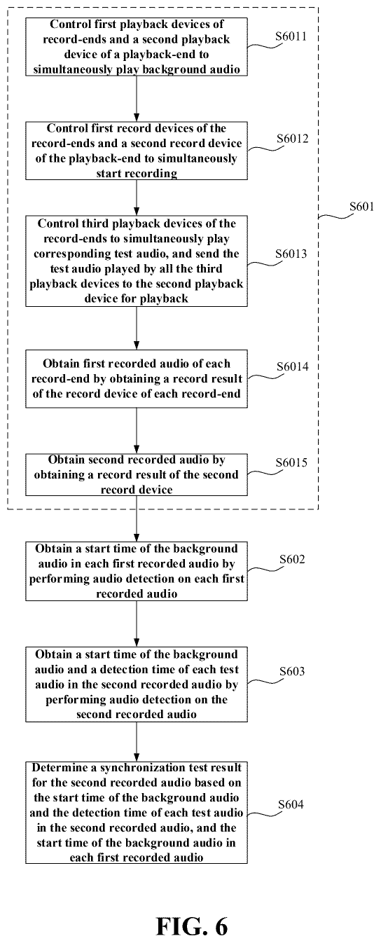

In this embodiment, an audio testing method is provided, which may be used in an electronic device, such as a computer and a mobile terminal. FIG. 6 is a flowchart of an audio testing method according to embodiments of the present disclosure. As shown in FIG. 6, the process includes the following steps:

Step S601: Obtain first recorded audio of each record-end and second recorded audio of a playback-end.

Both the first recorded audio and the second recorded audio include background audio that is simultaneously played, the first recorded audio further includes test audio which is in one-to-one correspondence with the record-ends, the test audios are played by playback devices of the record-ends, the second recorded audio is playback audio of the playback-end, and the playback audio includes the background audio and all test audio played by the playback-end.

Specifically, step S601 includes:

Step S6011: Control first playback devices of the record-ends and a second playback device of the playback-end to simultaneously play the background audio.

As shown in FIG. 1, the first playback devices in the record-ends and the second playback device in the playback-end simultaneously play the background audio. For example, a playback instruction is simultaneously sent to the first playback devices and the second playback device, so as to trigger the simultaneous playback of the background audio.

Step S6012: Control first record devices of the record-ends and a second record device of the playback-end to simultaneously start recording.

The time of starting recording by the first record devices and the second record device may be before, during, or after playing the background audio, which is not specifically limited herein. For example, a recording instruction is simultaneously sent to the first record devices and the second record device, so as to trigger simultaneous recording of the audio.

Step S6013: Control third playback devices of the record-ends to simultaneously play the corresponding test audio, and send the test audio played by all the third playback devices to the second playback device for playback.

All the test audios are simultaneously played. Based on this, a test audio playback instruction is simultaneously sent to the third playback devices, so as to trigger the simultaneous playback of the test audio. The test audio played by the third playback devices is collected by the first playback devices, and is sent by the first playback devices to the second playback device for playback. Therefore, the audio played by the second playback device includes the background audio and the test audio played by the record-ends.

Step S6014: Obtain first recorded audio of each record-end by obtaining a record result of the first record device of each record-end.

Step S6015: Obtain second recorded audio by obtaining a record result of the second record device.

The first record devices record the audio of the record-ends to obtain the first recorded audio, and the first recorded audio is in one-to-one correspondence with the record-ends. The second record device records the audio of the playback-end to obtain the second recorded audio.

Step S602: Obtain a start time of the background audio in each first recorded audio by performing audio detection on each first recorded audio. Please refer to step S302 in the embodiments shown in FIG. 1 for details, which are not repeated herein.

Step S603: Obtain a start time of the background audio and a detection time of each test audio in the second recorded audio by performing audio detection on the second recorded audio. Please refer to step S303 in the embodiments shown in FIG. 1 for details, which are not repeated herein.

Step S604: Determine a synchronization test result for the second recorded audio based on the start time of the background audio and the detection time of each test audio in the second recorded audio, and the start time of the background audio in each first recorded audio. Please refer to step S404 in the embodiments shown in FIG. 4 for details, which are not repeated herein.

According to the audio testing method provided in this embodiment, the playback of the background audio and the test audio and the recording by the record devices are performed through a control manner in the entire test process, without human participation. That is, the objective test is performed through the playback devices and the record devices, such that the synchronization test result is efficiently obtained through the method, and reproducibility is high.

As specific application embodiments of the embodiments of the present disclosure, with reference to FIG. 2, in the chorus scenario, 4 soundproof boxes are used to represent 4 record-ends, a player in each soundproof box is used to represent a singer, and a singing device is used to play the accompaniment, collect single-frequency tones played by the players, and then send the single-frequency tones to an audience device. Correspondingly, the audio played by the audience device includes the accompaniment and the single-frequency tones played by the players. There are four pieces of test audio corresponding to the four record-ends, and the single-frequency tones of different frequencies, but the same energy and duration are respectively generated at fixed positions in the test audio to simulate the voices of different singers. For example, single-frequency tones with frequencies of 0.25 KHz, 0.5 KHz, 0.75 KHz, and 1 KHz, each lasting 100 ms, are generated at the 6th second and the 7th second, thereby obtaining test audio which is in one-to-one correspondence with the singers. The frequency and the duration of the single-frequency tones in the test audio are set according to actual needs, which are not limited herein. Four pieces of first recorded audio are obtained through recording by the recorders 1 to 4, and the audience-end recorder performs recording to obtain second recorded audio. After obtaining the first recorded audio and the second recorded audio, processing is performed according to the audio testing method introduced above, thereby obtaining a synchronization test result for the second recorded audio.

The above metrics list A, list B, list C, and list D may characterize the alignment effect of a plurality of voices and the accompaniment heard by an audience in the real-time chorus scenario, as well as the synchronization degree of the local players of all the singers, and the alignment degree of the voices of all the singers heard at the audience end. A calculation result about the list D may also be derived from the list A. The list A measures the delay difference between the voice of each singer and the accompaniment heard by the audience, and the list D measures the delay difference between the voices of all the singers heard by the audience. For the list A and the list D, the difference between adjacent elements is equal. Therefore, the list D may be derived from the list A.

In this embodiment, an audio test apparatus is further provided. The apparatus is used to implement the above embodiments and preferred implementations, and details that have been described are not repeated. The term “module” used as below may implement a combination of software and/or hardware with preset functions. An apparatus described in the following embodiments is preferably implemented by the software, but it is possible and conceivable for implementing the apparatus through the hardware or a combination of the software and the hardware.

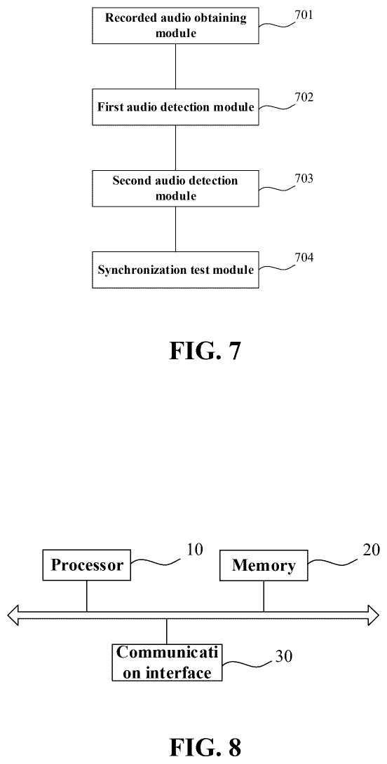

Embodiments provide an audio test apparatus, and as shown in FIG. 7, including:
a recorded audio obtaining module 701, configured to obtain first recorded audio of each record-end and second recorded audio of a playback-end, wherein both the first recorded audio and the second recorded audio comprise background audio that is simultaneously played, the first recorded audio further comprises test audios which are in one-to-one correspondence with the record-ends, the test audios are played by playback devices of the record-ends, the second recorded audio is playback audio of the playback-end, and the playback audio comprises the background audio and all test audio played by the playback-end;
a first audio detection module 702, configured to obtain a start time of the background audio in each first recorded audio by performing audio detection on each first recorded audio;
a second audio detection module 703, configured to obtain a start time of the background audio and a detection time of each test audio in the second recorded audio by performing audio detection on the second recorded audio; and
a synchronization test module 704, configured to determine a synchronization test result for the second recorded audio based on the start time of the background audio and the detection time of each test audio in the second recorded audio, and the start time of the background audio in each first recorded audio.

In some optional implementations, the test audios are simultaneously played, and the synchronization test module 704 includes:
a start time obtaining unit, configured to obtain a reference start time by obtaining a start time of the background audio in first recorded audio of a reference record-end;
a start delay determining unit, configured to determine a start delay of the background audio in the second recorded audio based on a difference between the start time of the background audio in the second recorded audio and the reference start time;
a playback time obtaining unit, configured to obtain a test audio playback time by obtaining a time when the test audio is played simultaneously; and
a synchronization test unit, configured to determine a synchronization test result for the second recorded audio based on the detection time of each test audio in the second recorded audio, the start delay of the background audio in the second recorded audio, and the start time of the background audio in each first recorded audio.

In some optional implementations, the synchronization test unit includes:
a test audio time difference determining subunit, configured to obtain a test audio time difference corresponding to each record-end based on a difference between a detection time of the test audio corresponding to each record-end in the second recorded audio and the test audio playback time;
a background audio time difference determining subunit, configured to obtain a background audio time difference corresponding to each record-end based on a difference between the start delay of the background audio and the start time of the background audio in each first recorded audio; and
an audio asynchrony degree determining subunit, configured to obtain, for each record-end, an asynchrony degree between the test audio and the background audio based on a difference between the test audio time difference and the background audio time difference, where the synchronization test result includes the background audio time difference corresponding to each record-end and the asynchrony degree between the test audio and the background audio.

In some optional implementations, the synchronization test unit further includes:
a reference start time obtaining subunit, configured to obtain a reference start time of the test audio by obtaining a detection time of test audio corresponding to the reference record-end in the second recorded audio; and
a first test audio synchronization test result determining subunit, configured to obtain a first test audio synchronization test result corresponding to each record-end based on a difference between the detection time of each test audio in the second recorded audio and the reference start time of the test audio.

In some optional implementations, the synchronization test unit further includes:
a second synchronization test result of test audio determining subunit, configured to obtain a second synchronization test result of test audio corresponding to each record-end based on a sum of the start times of the background audio in the each first recorded audio and the first synchronization test results of test audio corresponding to each record-end.

In some optional implementations, the synchronization test unit further includes:
a comparison subunit, configured to obtain a maximum value and a minimum value of the second synchronization test results of test audio by comparing the second synchronization test results of test audio corresponding to the record-ends; and
a maximum relative delay difference determining subunit, configured to obtain a maximum relative delay difference of the test audio based on a difference between the maximum value and the minimum value.

In some optional implementations, the recorded audio obtaining module 701 includes:
a first control unit, configured to control first playback devices of the record-ends and a second playback device of the playback-end to simultaneously play the background audio;
a second control unit, configured to control first record devices of the record-ends and a second record device of the playback-end to simultaneously start recording;
a third control unit, configured to control third playback devices of the record-ends to simultaneously play the corresponding test audio, and send the test audio played by all the third playback devices to the second playback device for playback;
a first record result obtaining unit, configured to obtain first recorded audio of each record-end by obtaining a record result of the first record device of each record-end; and
a second record result obtaining unit, configured to obtain second recorded audio by obtaining a record result of the second record device.

The audio test apparatus in the embodiments is presented in the form of a functional unit. The unit refers to an application specific integrated circuit (ASIC), a processor and a memory executing one or more software or fixed programs, and/or other devices that may provide the above functions.

Further functional descriptions of the above various modules and units are the same as those in the above corresponding embodiments, which are not repeated herein.

Embodiments of the present disclosure further provide an electronic device, having the audio test apparatus shown in FIG. 7 above.

Referring to FIG. 8, FIG. 8 is a schematic diagram of a structure of an electronic device according to optional embodiments of the present disclosure. As shown in FIG. 8, the electronic device includes: one or more processors 10, a memory 20, as well as interfaces for connecting various components, including a high-speed interface and a low-speed interface. The various components are in mutual communication connection using different buses and may be installed on a common motherboard or installed in other methods as needed. The processor may process instructions executed within the electronic device, including instructions stored in or on the memory to display graphical information of a graphical user interface (GUI) on an external input/output apparatus (e.g., a display device coupled to an interface). In some optional implementations, a plurality of processors and/or a plurality of buses may be used together with a plurality of memories as needed. Similarly, a plurality of electronic devices may be connected. Each device provides some necessary operations (e.g., as a server array, a set of blade servers, or a multiprocessor system). One processor 10 is used as an example in FIG. 8.

The processor 10 may be a central processing unit, a network processor, or a combination thereof. The processor 10 may further include a hardware chip. The above hardware chip may be an application specific integrated circuit, a programmable logic device, or a combination thereof. The programmable logic device may be a complex programmable logic device, a field-programmable gate array, a generic array logic, or any combination thereof.

The memory 20 stores instructions executable by at least one processor 10, such that the at least one processor 10 performs the method shown in the above embodiments.

The memory 20 may include a program storage area and a data storage area. The program storage area may store an operating system and an application required by at least one function. The data storage area may store data, etc. created based on the use of the electronic device. In addition, the memory 20 may include a high-speed random access memory, and may also include a non-transitory memory, such as at least one disk storage device, at least one flash memory device, or other non-transitory solid-state storage devices. In some optional implementations, the memory 20 optionally includes memories remotely set relative to the processor 10. These remote memories may be connected to the electronic device through a network. The examples of the above network include, but are not limited to, an Internet, an intranet, a local area network, a mobile communication network, and a combination thereof.

The memory 20 may include a volatile memory, such as a random access memory. The memory may also include a non-volatile memory, such as a flash memory, a hard drive, or a solid-state drive. The memory 20 may further include combinations of the above types of memories.

The electronic device further includes a communication interface 30, configured for data communication between the electronic device and other devices or communication networks.

Embodiments of the present disclosure further provide a computer-readable storage medium. The method according to the embodiments of the present disclosure may be implemented in hardware and firmware, or may be implemented as computer code that can be recorded on a storage medium, or is downloaded through the network and originally stored on a remote storage medium or a non-transitory machine-readable storage medium and then is stored on a local storage medium, and therefore the method described herein may be processed by software that is stored on a storage medium using a general-purpose computer, a dedicated processor, or programmable or specialized hardware. The storage medium may be a magnetic disk, an optical disk, a read-only memory, a random access memory, a flash memory, a hard drive, a solid-state drive, or the like. Further, the storage medium may also include combinations of the above types of memories. It should be understood that a computer, a processor, a microprocessor controller, or programmable hardware includes a storage component that can store or receive software or computer code. When the software or the computer code is accessed and executed by the computer, the processor, or the hardware, the method shown in the above embodiments is implemented.

Although the embodiments of the present disclosure are described with reference to the accompanying drawings, those skilled in the art may make various modifications and variations without departing from the spirit and scope of the present disclosure, and such modifications and variations fall within the scope defined by the appended claims.

1. An audio testing method, comprising:
obtaining first recorded audio of each record-end and second recorded audio of a playback-end, both the first recorded audio and the second recorded audio comprising background audio that is simultaneously played, the first recorded audio further comprising test audios which are in one-to-one correspondence with the record-ends, the test audios being played by playback devices of the record-ends, the second recorded audio being playback audio of the playback-end, and the playback audio comprising the background audio and all test audio played by the playback-end;
obtaining a start time of the background audio in each first recorded audio by performing audio detection on each first recorded audio;
obtaining a start time of the background audio and a detection time of each test audio in the second recorded audio by performing audio detection on the second recorded audio; and
determining a synchronization test result for the second recorded audio based on the start time of the background audio and the detection time of each test audio in the second recorded audio, and the start time of the background audio in each first recorded audio.

2. The method according to claim 1, wherein the test audios are simultaneously played, and determining the synchronization test result for the second recorded audio based on the start time of the background audio and the detection time of each test audio in the second recorded audio, and the start time of the background audio in each first recorded audio comprises:
obtaining a reference start time by obtaining a start time of the background audio in first recorded audio of a reference record-end;
determining a start delay of the background audio in the second recorded audio based on a difference between the start time of the background audio in the second recorded audio and the reference start time;
obtaining a test audio playback time by obtaining a time when the test audio is played simultaneously; and
determining a synchronization test result for the second recorded audio based on the detection time of each test audio in the second recorded audio, the start delay of the background audio in the second recorded audio, and the start time of the background audio in each first recorded audio.

3. The method according to claim 2, wherein determining the synchronization test result for the second recorded audio based on the detection time of each test audio in the second recorded audio, the start delay of the background audio in the second recorded audio, and the start time of the background audio in each first recorded audio comprises:
obtaining a test audio time difference corresponding to each record-end based on a difference between a detection time of the test audio corresponding to each record-end in the second recorded audio and the test audio playback time;
obtaining a background audio time difference corresponding to each record-end based on a difference between the start delay of the background audio and the start time of the background audio in each first recorded audio; and
obtaining, for each record-end, an asynchrony degree between the test audio and the background audio based on a difference between the test audio time difference and the background audio time difference, wherein the synchronization test result comprises the background audio time difference corresponding to each record-end and the asynchrony degree between the test audio and the background audio.

4. The method according to claim 2, wherein determining the synchronization test result for the second recorded audio based on the start time of the background audio and the detection time of each test audio in the second recorded audio, and the start time of the background audio in each first recorded audio further comprises:
obtaining a reference start time of the test audio by obtaining a detection time of test audio corresponding to the reference record-end in the second recorded audio; and
obtaining a first test audio synchronization test result corresponding to each record-end based on a difference between the detection time of each test audio in the second recorded audio and the reference start time of the test audio.

5. The method according to claim 4, wherein determining the synchronization test result for the second recorded audio based on the start time of the background audio and the detection time of each test audio in the second recorded audio, and the start time of the background audio in each first recorded audio further comprises:
obtaining a second synchronization test result of test audio corresponding to each record-end based on a sum of the start times of the background audio in the each first recorded audio and the first synchronization test results of test audio corresponding to each record-end.

6. The method according to claim 5, wherein determining the synchronization test result for the second recorded audio based on the start time of the background audio and the detection time of each test audio in the second recorded audio, and the start time of the background audio in each first recorded audio further comprises:
obtaining a maximum value and a minimum value of the second synchronization test results of test audio by comparing the second synchronization test results of test audio corresponding to the record-ends; and
obtaining a maximum relative delay difference of the test audio based on a difference between the maximum value and the minimum value.

7. The method according to claim 1, wherein obtaining the first recorded audio of each record-end and the second recorded audio of the playback-end comprises:
controlling first playback devices of the record-ends and a second playback device of the playback-end to simultaneously play the background audio;
controlling first record devices of the record-ends and a second record device of the playback-end to simultaneously start recording;
controlling third playback devices of the record-ends to simultaneously play the corresponding test audio, all the test audio played by the third playback devices being sent to the second playback device for playback;
obtaining first recorded audio of each record-end by obtaining a record result of the first record device of each record-end; and
obtaining second recorded audio by obtaining a record result of the second record device.

8. An electronic device, comprising:
a memory and a processor, wherein the memory and the processor are in mutual communication connection, the memory stores computer instructions, and the computer instructions, when executed by the processor, cause the device to:
obtain first recorded audio of each record-end and second recorded audio of a playback-end, both the first recorded audio and the second recorded audio comprising background audio that is simultaneously played, the first recorded audio further comprising test audios which are in one-to-one correspondence with the record-ends, the test audios being played by playback devices of the record-ends, the second recorded audio being playback audio of the playback-end, and the playback audio comprising the background audio and all test audio played by the playback-end;
obtain a start time of the background audio in each first recorded audio by performing audio detection on each first recorded audio;
obtain a start time of the background audio and a detection time of each test audio in the second recorded audio by performing audio detection on the second recorded audio; and
determine a synchronization test result for the second recorded audio based on the start time of the background audio and the detection time of each test audio in the second recorded audio, and the start time of the background audio in each first recorded audio.

9. The electronic device according to claim 8, wherein the test audios are simultaneously played, and the computer instructions causing the electronic device to determine the synchronization test result for the second recorded audio based on the start time of the background audio and the detection time of each test audio in the second recorded audio, and the start time of the background audio in each first recorded audio further cause the electronic device to:
obtain a reference start time by obtaining a start time of the background audio in first recorded audio of a reference record-end;
determine a start delay of the background audio in the second recorded audio based on a difference between the start time of the background audio in the second recorded audio and the reference start time;
obtain a test audio playback time by obtaining a time when the test audio is played simultaneously; and
determine a synchronization test result for the second recorded audio based on the detection time of each test audio in the second recorded audio, the start delay of the background audio in the second recorded audio, and the start time of the background audio in each first recorded audio.

10. The electronic device according to claim 9, wherein the computer instructions causing the electronic device to determine the synchronization test result for the second recorded audio based on the detection time of each test audio in the second recorded audio, the start delay of the background audio in the second recorded audio, and the start time of the background audio in each first recorded audio further cause the electronic device to:
obtain a test audio time difference corresponding to each record-end based on a difference between a detection time of the test audio corresponding to each record-end in the second recorded audio and the test audio playback time;
obtain a background audio time difference corresponding to each record-end based on a difference between the start delay of the background audio and the start time of the background audio in each first recorded audio; and
obtain, for each record-end, an asynchrony degree between the test audio and the background audio based on a difference between the test audio time difference and the background audio time difference, wherein the synchronization test result comprises the background audio time difference corresponding to each record-end and the asynchrony degree between the test audio and the background audio.

11. The electronic device according to claim 9, wherein the computer instructions causing the electronic device to determine the synchronization test result for the second recorded audio based on the start time of the background audio and the detection time of each test audio in the second recorded audio, and the start time of the background audio in each first recorded audio further cause the electronic device to:
obtain a reference start time of the test audio by obtaining a detection time of test audio corresponding to the reference record-end in the second recorded audio; and
obtain a first test audio synchronization test result corresponding to each record-end based on a difference between the detection time of each test audio in the second recorded audio and the reference start time of the test audio.

12. The electronic device according to claim 11, wherein the computer instructions causing the electronic device to determine the synchronization test result for the second recorded audio based on the start time of the background audio and the detection time of each test audio in the second recorded audio, and the start time of the background audio in each first recorded audio further cause the electronic device to:
obtain a second synchronization test result of test audio corresponding to each record-end based on a sum of the start times of the background audio in the each first recorded audio and the first synchronization test results of test audio corresponding to each record-end.

13. The electronic device according to claim 12, wherein the computer instructions causing the electronic device to determine the synchronization test result for the second recorded audio based on the start time of the background audio and the detection time of each test audio in the second recorded audio, and the start time of the background audio in each first recorded audio further cause the electronic device to:
obtain a maximum value and a minimum value of the second synchronization test results of test audio by comparing the second synchronization test results of test audio corresponding to the record-ends; and
obtain a maximum relative delay difference of the test audio based on a difference between the maximum value and the minimum value.

14. The electronic device according to claim 8, wherein the computer instructions causing the electronic device to obtain the first recorded audio of each record-end and the second recorded audio of the playback-end further cause the electronic device to:
control first playback devices of the record-ends and a second playback device of the playback-end to simultaneously play the background audio;
control first record devices of the record-ends and a second record device of the playback-end to simultaneously start recording;
control third playback devices of the record-ends to simultaneously play the corresponding test audio, all the test audio played by the third playback devices being sent to the second playback device for playback;
obtain first recorded audio of each record-end by obtaining a record result of the first record device of each record-end; and
obtain second recorded audio by obtaining a record result of the second record device.

15. An audio test system, comprising:
a plurality of record-ends, each record-end comprising a first playback device, a third playback device, and a first record device, all the first playback devices being configured to simultaneously play background audio, the third playback devices being configured to simultaneously play test audio corresponding to the record-ends, and the first record devices being configured to record the background audio and the test audio to obtain first recorded audio;
a playback-end, comprising a second playback device and a second record device, the second playback device being configured to play the test audio played by all the third playback devices and to play the background audio simultaneously with the first playback devices, and the second record device being configured to record the audio played by the second playback device to obtain second recorded audio; and
an electronic device, the electronic device being respectively connected with the devices of the record-ends and the playback-end, the electronic device comprising a memory and a processor, the memory and the processor being in mutual communication connection, the memory storing computer instructions, and the computer instructions, when executed by the processor, causing the electronic device to:
obtain first recorded audio of each record-end and second recorded audio of a playback-end, both the first recorded audio and the second recorded audio comprising background audio that is simultaneously played, the first recorded audio further comprising test audios which are in one-to-one correspondence with the record-ends, the test audios being played by playback devices of the record-ends, the second recorded audio being playback audio of the playback-end, and the playback audio comprising the background audio and all test audio played by the playback-end;
obtain a start time of the background audio in each first recorded audio by performing audio detection on each first recorded audio;
obtain a start time of the background audio and a detection time of each test audio in the second recorded audio by performing audio detection on the second recorded audio; and
determine a synchronization test result for the second recorded audio based on the start time of the background audio and the detection time of each test audio in the second recorded audio, and the start time of the background audio in each first recorded audio.

16. The system according to claim 15, wherein the test audios are simultaneously played, and the computer instructions causing the electronic device to determine the synchronization test result for the second recorded audio based on the start time of the background audio and the detection time of each test audio in the second recorded audio, and the start time of the background audio in each first recorded audio further cause the electronic device to:
obtain a reference start time by obtaining a start time of the background audio in first recorded audio of a reference record-end;
determine a start delay of the background audio in the second recorded audio based on a difference between the start time of the background audio in the second recorded audio and the reference start time;
obtain a test audio playback time by obtaining a time when the test audio is played simultaneously; and
determine a synchronization test result for the second recorded audio based on the detection time of each test audio in the second recorded audio, the start delay of the background audio in the second recorded audio, and the start time of the background audio in each first recorded audio.

17. The system according to claim 16, wherein the computer instructions causing the electronic device to determine the synchronization test result for the second recorded audio based on the detection time of each test audio in the second recorded audio, the start delay of the background audio in the second recorded audio, and the start time of the background audio in each first recorded audio further cause the electronic device to:
obtain a test audio time difference corresponding to each record-end based on a difference between a detection time of the test audio corresponding to each record-end in the second recorded audio and the test audio playback time;
obtain a background audio time difference corresponding to each record-end based on a difference between the start delay of the background audio and the start time of the background audio in each first recorded audio; and
obtain, for each record-end, an asynchrony degree between the test audio and the background audio based on a difference between the test audio time difference and the background audio time difference, wherein the synchronization test result comprises the background audio time difference corresponding to each record-end and the asynchrony degree between the test audio and the background audio.

18. The system according to claim 16, wherein the computer instructions causing the electronic device to determine the synchronization test result for the second recorded audio based on the start time of the background audio and the detection time of each test audio in the second recorded audio, and the start time of the background audio in each first recorded audio further cause the electronic device to:
obtain a reference start time of the test audio by obtaining a detection time of test audio corresponding to the reference record-end in the second recorded audio; and
obtain a first test audio synchronization test result corresponding to each record-end based on a difference between the detection time of each test audio in the second recorded audio and the reference start time of the test audio.

19. The system according to claim 18, wherein the computer instructions causing the electronic device to determine the synchronization test result for the second recorded audio based on the start time of the background audio and the detection time of each test audio in the second recorded audio, and the start time of the background audio in each first recorded audio further cause the electronic device to:
obtain a second synchronization test result of test audio corresponding to each record-end based on a sum of the start times of the background audio in the each first recorded audio and the first synchronization test results of test audio corresponding to each record-end.

20. The system according to claim 19, wherein the computer instructions causing the electronic device to determine the synchronization test result for the second recorded audio based on the start time of the background audio and the detection time of each test audio in the second recorded audio, and the start time of the background audio in each first recorded audio further cause the electronic device to:
obtain a maximum value and a minimum value of the second synchronization test results of test audio by comparing the second synchronization test results of test audio corresponding to the record-ends; and
obtain a maximum relative delay difference of the test audio based on a difference between the maximum value and the minimum value.
